(19) United States
(12) Patent Application Publication
(10) Pub. No.: US 2015/0371572 A1
(43) Pub. Date: Dec. 24, 2015

(54) WRITABLE/ERASABLE AND REUSABLE STEMWARE USER IDENTIFICATION STICKER

(71) Applicant: Walter J. Averill, Windsor, CA (US)

(72) Inventor: Walter J. Averill, Windsor, CA (US)

(21) Appl. No.: 14/746,775

(22) Filed: Jun. 22, 2015

Related U.S. Application Data
(60) Provisional application No. 62/015,298, filed on Jun. 20, 2014.
(60) Provisional application No. 62/022,159, filed on Jul. 8, 2014.

(51) Int. Cl. G09F 19/00; G09F 3/02; G09F 3/04

(52) U.S. Cl. CPC G09F 19/00; G09F 3/04; G09F 3/02

(57) ABSTRACT

A glassware and stemware user identification apparatus including a food grade silicone planar resilient member sized and shaped for application to smooth surfaced glassware. The planar resilient member has at least one surface with a polished finished to accept writable/erasable markings by a suitable pen. The planar resilient member may be annular with a split so as to enable placement around the stem of conventional stemware, or a simple shape for placement on the bowl or container portion of the glassware.

### CROSS REFERENCES TO RELATED APPLICATIONS

The present application claims the benefit of U.S. Provisional Patent Application Ser. No. 62/015,298, filed Jun. 20, 2014 and U.S. Provisional Patent Application Ser. No. 62/022,159, filed Jul. 8, 2014 , each of which are incorporated in their entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates most generally to means for marking indistinguishable objects, and more particularly to a method and apparatus for identifying the user of stemware.

2. Background Discussion

At parties and other crowded occasions, it is not uncommon for wine drinkers to set down a glass only to lose track of it and confuse it with glasses belonging to others. The problem is so common that numerous methods of marking and identifying stemware and bottles have been proposed. Exemplary patents from a long list various designs and utility publications include:

U.S. Pat. No. 6,293,034 to Skapyak, which teaches a wine bottle ring for a bottle or glass formed of spring steel in a loop having a pair of opposing and abutting ends. The loops are of a size for accepting a stem of a wine glass and for being supported on a base of a wine glass. The rings have a distinctive ornamentation to distinguish the wine glasses from one another.

U.S. Pat. No. 5,339,549 to David, et al., describes a tag system comprising a plurality of split ring tags having sufficient stiffness to normally retain its opposed end edges aligned, maintaining a gap therebetween smaller than a handle cross section, and having resilience and a shape memory to allow manual tag flexing so as to allow any tag to be fitted onto or removed from a container handle. The tags are distinguished by shape and internal inside features. No means are shown for marking the tag with a specific user identification.

U.S. Pat. No. 6,741,150 to Holmes, et al, discloses a wine glass charm with a magnetic coupling, the components of which are disposed at the respective ends of an encircling member to detachably attach the wine glass charm to the stem or handle of a drinking vessel. The encircling member may include identifying indicia or media and for further identification purposes a uniquely configured charm may be supported therefrom.

U.S. Pat. No. D496,220, shows an ornamental wire coil having closed loop terminal ends, one of which includes a charm suspended therefrom. The coils are separated for placement over the rim of a glass.

U.S. Pat. No. D426,267 to Bush, shows an ornamental label for stemmed glassware comprising a generally planar ring of no substantial thickness and having a split for placement around a glass stem. No material is suggested, taught, or otherwise indicated, and no means for writing a user's name are disclosed.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

Many of the articles described in the foregoing patents are clearly intended to be reusable, but other than disposable paper, none have reusable means for identifying a particular user—the identification is anonymous. Of those that are reusable, many include metal chains, bracelets, etc., some having means for attaching icons or charms or other identifying indicia. However, for those of us with less than perfect memories, they are less than perfect. It is not uncommon, for instance, that a host or hostess assigns a glass and attaches a unique identifier on the glass. It is then up to the user assigned a particular glass to take notice and remember the particular identifier. Users don't always do that. Sometimes a guest/wine drinker forgets which charm is his or hers and boorishly picks up the wrong glass without seeking to confirm the choice. If not quickly corrected, that “forgetting” can become downright infectious, in more ways than one. Moreover, sometimes the unique identifiers are not all that unique, or at least they may be so similar that problems occur not so much due to forgetting, but due to users confusing the charms or other identifying articles. This can be particular annoying when the hapless user whose glass has been taken has been poured the very last of a bottle of 1967 Domaine de la Romanee-Conti, and the (innocent) boor who took the glass has left an off flavored wine in its place (“annoying” admittedly being an understatement for such circumstances).

In addition, charms can be an unwelcome to stemware. Loosely applied hard metal or plastic charms and bracelets can clink and rattle when the stemware is swirled to aerate wine. This can be annoying and can even make the act a bit clumsy.

There remains a need, therefore, for a simple and essentially foolproof way of identifying stemware so as to prevent the unintended “sharing” of wines and diseases by forgetful persons, boors, drunks, clever opportunists, and temporary amnesia sufferers.

### BRIEF SUMMARY OF THE INVENTION

The present invention solves the foregoing problem by providing a silicone-based erasable/washable and reusable sticker, either in the form of a sticky tag or a collar, for placement either on the side or around the stem and over the base of stemware, which indicates the drinker to whom the stemware has been assigned and (at least temporarily) belongs.

### BRIEF DESCRIPTION OF SEVERAL VIEWS OF THE DRAWINGS

FIG. 1A is an upper perspective view showing the inventive stemware user identification apparatus in the form of a collar disposed around the stem and upon the base of a wine glass, showing the collar with a name written on its upper surface;

FIG. 1B shows the same collar with the user name erased;

FIG. 2 shows the same collar with the collar slot separated for placement around a glass stem;

FIG. 3A is a top plan view thereof;

FIG. 3B is a top plan thereof with the user name written on the collar upper surface;

FIG. 3C suggests the simple method of erasing the written name;

FIG. 3D shows how readily a new name can be written on the identification collar;

FIG. 4A is an upper perspective view showing use of a second preferred embodiment of the identification sticker to label a glass on its base portion, this embodiment comprising a simple oval-shaped sticker;

FIG. 4B is the same view showing the sticker removed and replaced on the side of the drinking/wine glass;

FIG. 5 is an upper perspective view showing the inventive writable/erasable and reusable sticker;

FIG. 6A is a top plan view showing the sticker with no identifying name written on its surface;

FIG. 6B is the same view showing a user's name written on the top surface;

FIG. 6C shows how an erasure is accomplished; and

FIG. 6D is a top plan view showing a new user name written on the sticker top surface.

### DETAILED DESCRIPTION OF THE INVENTION

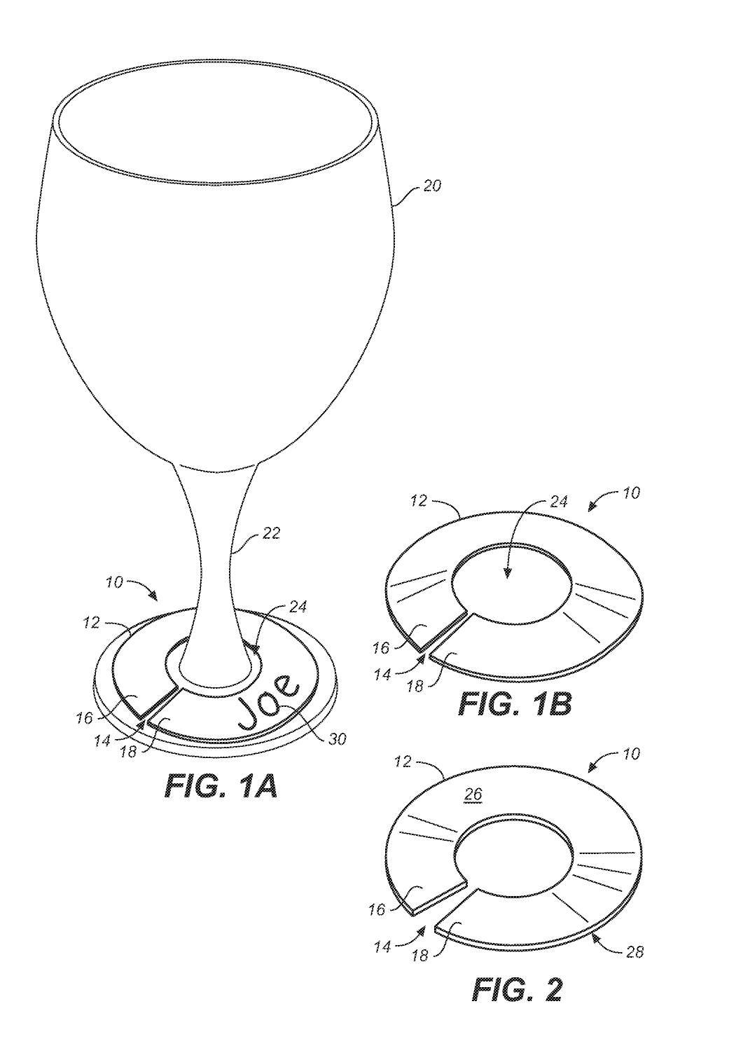

Referring first to FIGS. 1 through 3D, wherein like reference numerals refer to like components in the various views, there is illustrated therein a first preferred embodiment of a new and improved writable/erasable and reusable stemware user identification sticker, generally denominated 10 herein. In the first preferred embodiment, the sticker is provided in the form of an annular collar comprising a resilient annulus 12, preferably fabricated from food grade silicone, and includes a slot 14 for separating first and second ends 16, 18 so as to allow insertion of a glass ware 20 stem 22 into the collar, such that the center hole 24 of the collar wraps around and captures the stem 22.

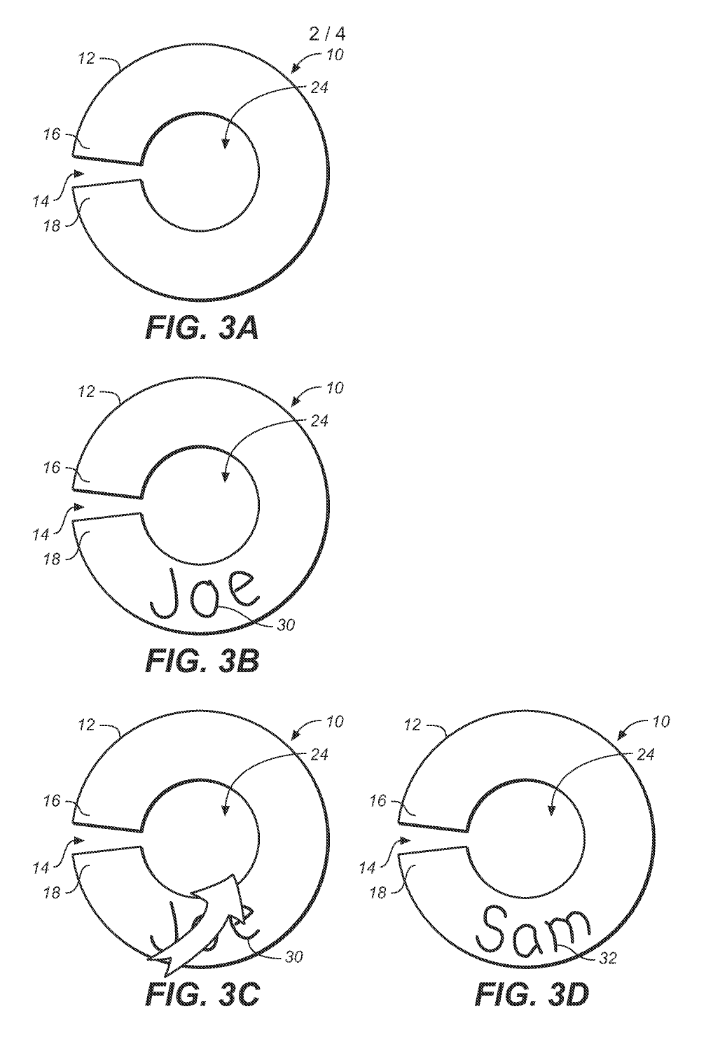

The collar is much like a flat or fender washer with a split or slot. It is thus annular and generally planar, and most importantly includes writable/erasable upper and lower surfaces 26, 28, so that a user name 30 can be written on either side. When desired, a first user name 30 (e.g., “Joe”) can be erased (see FIG. 3C) and replaced with a second user name 32 (e.g., “Sam”). The material employed to enable the readable/writable surfaces is preferably silicone rubber containing white carbon black and reinforced with fumed silica. The collars have polished upper and lower surfaces and the composition has an ASTM Shore A hardness of 35. This provides resilience, pliability, and a slight stickiness, and along with the split these features ensure that that the collar can be pressed downwardly onto the slightly angled or beveled foot (base or footer) of a wine glass. The slight stickiness ensures that it adheres nicely to the stemware foot. However, it is readily pulled away after use for cleaning and reuse. This contrasts with known identification devices that may fall or slide off the glass when tilted or, in the case of paper tags, are discarded after use.

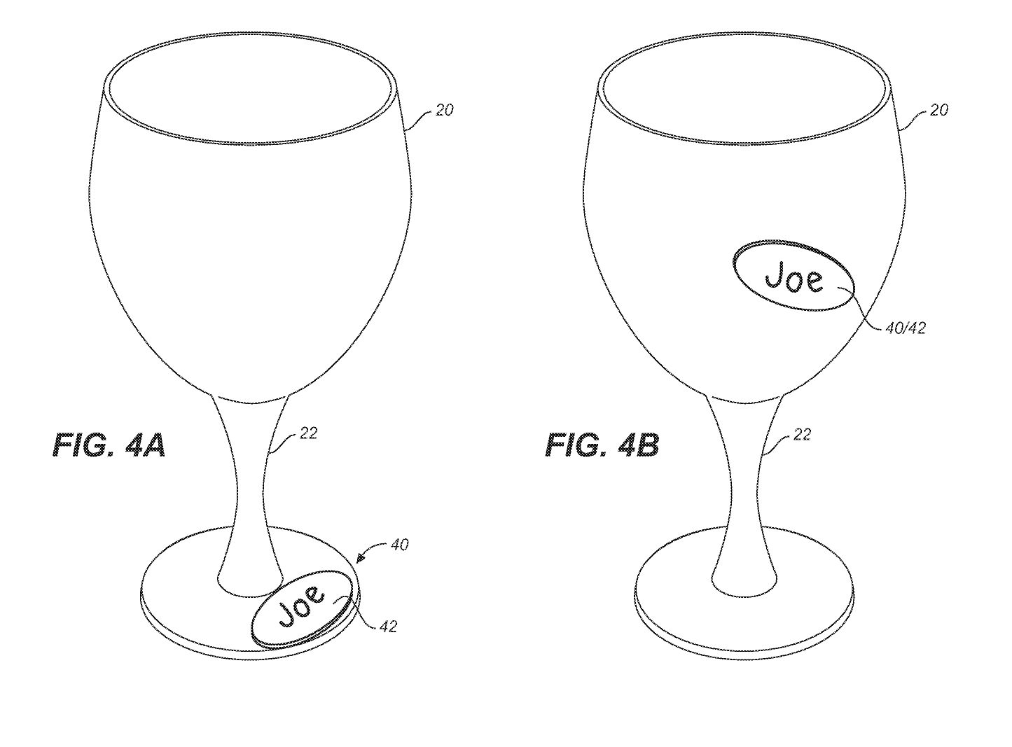

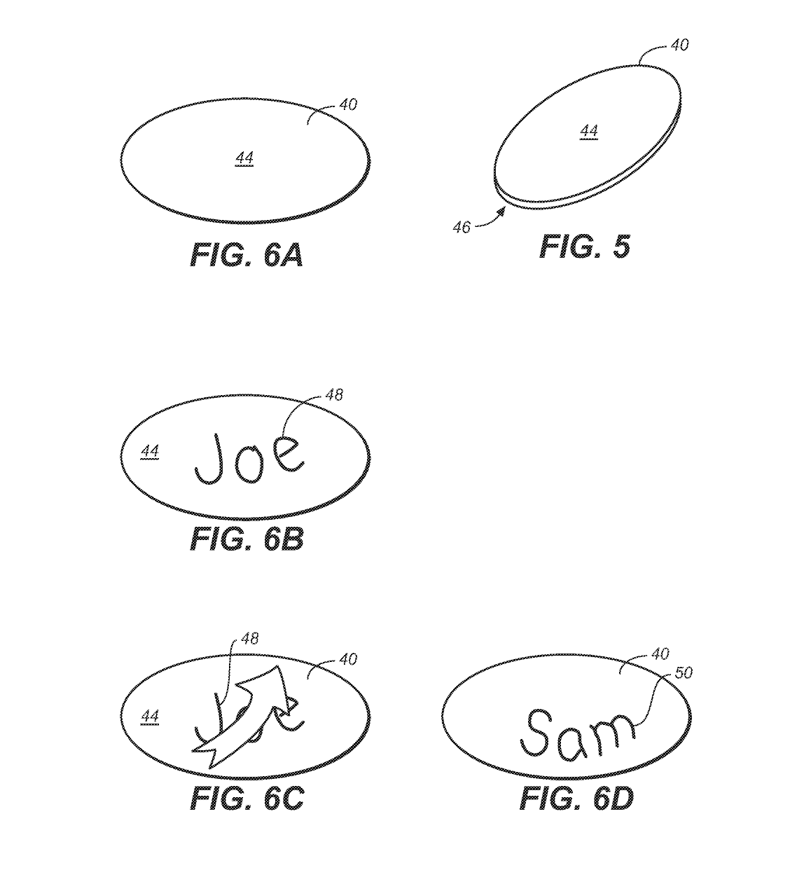

Referring next to FIGS. 4A through 6D, there is shown a second preferred embodiment 40 of the inventive writable/erasable and reusable identification sticker for stemware. In this embodiment the sticker comprises a simple oval tag 42, again fabricated from food grade silicone as described above. The tag is sized so as to allow placement on nearly any portion of conventionally sized glass ware 20. The sticker is planar, flexible, and includes at least a writable/erasable upper surface 44, and preferably writable/erasable upper and lower surfaces, 44, 46 so that a first user name 48 can be written on either side. When desired, the first user name 48 can be erased (see FIG. 6C) and replaced with a second user name 50. The material employed, along with tag sizing, enables the sticker to adhere suitably well to any portion of the glassware. This makes the tag suitable for use with essentially any kind of glassware having smoother exterior surface, including glassware other than stemware.

It will therefore be appreciated that in its most essential aspect, the glassware and stemware user identification apparatus of the present invention is a food grade silicone planar resilient member sized and shaped for application to smooth surfaced glassware. The planar resilient member has at least one surface with a polished finished to accept writable/erasable markings by a suitable pen. The planar resilient member may be annular with a split so as to enable placement around the stem of conventional stemware, or a simple shape for placement on the bowl or container portion of the glassware.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, the disclosure herein does not limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative structural arrangements, sizes, shapes, forms, functions, operational features or the like.

Therefore, the above description and illustrations should not be construed as limiting the scope of the invention, which is defined by the appended claims.

What is claimed as invention is:

1. Glassware user identification apparatus, comprising a planar resilient member fabricated from food grade silicone and sized for application to glassware having a smooth exterior surface, said planar resilient member having at least one surface finished to enable writable/erasable markings by a suitable pen.

2. The apparatus of claim 1, wherein said planar resilient member is annular.

3. The apparatus of claim 2, wherein said planar resilient member includes a center hole and a slot so as enable easy placement around the stem and onto the base of stemware, thereby capturing the stem.

4. The apparatus of claim 1, wherein said planar resilient member has writable/erasable upper and lower surfaces.

5. The apparatus of claim 1, wherein said planar resilient member is fabricated from silicone rubber containing white carbon black and reinforced with fumed silica.

6. The apparatus of claim 5, wherein said planar resilient member have polished upper and lower surfaces.

7. The apparatus of claim 6, wherein the material composition of said planar resilient member has an ASTM Shore A hardness of 35.

8. The apparatus of claim 1, wherein said planar resilient member have polished upper and lower surfaces.

9. The apparatus of claim 8, wherein the material composition of said planar resilient member has an ASTM Shore A hardness of 35.

10. The apparatus of claim 1, wherein said planar resilient member is an oval tag.
